(19) United States
(12) Patent Application Publication
(10) Pub. No.: US 2023/0167300 A1
(43) Pub. Date: Jun. 1, 2023

(54) RESIN COMPOSITION

(71) Applicant: NAN YA PLASTICS CORPORATION, TAIPEI (TW)

(72) Inventors: Te-Chao Liao, TAIPEI (TW); Chien Kai Wei, TAIPEI (TW); Hung-Yi Chang, TAIPEI (TW)

(73) Assignee: NAN YA PLASTICS CORPORATION, TAIPEI (TW)

(21) Appl. No.: 17/903,063

(22) Filed: Sep. 6, 2022

(30) Foreign Application Priority Data
Nov. 26, 2021 (TW) 110144103

(51) Int. Cl. C08L 79/08

(52) U.S. Cl. CPC C08L 79/08; C08L 2312/00; C08L 2201/02; C08L 2203/20

(57) ABSTRACT

A resin composition including resin and other additives is provided. The resin includes bisphenol M-type cyanate ester (CE) resin and bismaleimide (BMI) resin. The other additives are selected from at least one of flame retardants, inorganic fillers, and accelerators.

### CROSS-REFERENCE TO RELATED APPLICATION

This application claims the priority benefit of Taiwan application no. 110144103 filed on Nov. 26, 2021. The entirety of the above-mentioned patent applications is hereby incorporated by reference herein and made a part of this specification.

### BACKGROUND

### Technical Field

The disclosure relates to a composition, particularly to a resin composition.

### Description of Related Art

Because of its crosslinked structure and the high heat resistance or dimensional stability, the composition of thermosetting resin is widely used in electronic equipment among many other fields. Although the cyanate ester (CE) resin used in the thermosetting resin has the characteristics of flame retardancy and high glass transition temperature (Tg), the substrates made thereof cannot achieve better performance in terms of heat resistance and the electrical properties due to reactivity reasons. Higher frequencies (for example, 6-77 GHz) are used by mobile phones, base stations, servers, and so on due to the development of 5G communication and millimeter wave communication in recent years, and therefore it is necessary to design a substrate material more suitable for 5G high frequency.

### SUMMARY

The disclosure provides a resin composition, which may be adapted as a substrate material more suitable for 5G high frequency, and may effectively improve the heat resistance and the electrical properties of the substrate made by the resin composition.

A resin composition of the disclosure includes resin and other additives. The resin includes bisphenol M-type cyanate ester (CE) resin and bismaleimide (BMI) resin. These other additives are selected from at least one of flame retardants, inorganic fillers, and accelerators.

In an embodiment of the disclosure, the proportion of the bisphenol M-type cyanate ester resin in the resin is 10 wt % to 30 wt %.

In an embodiment of the disclosure, the proportion of the bismaleimide resin in the resin is 40 wt % to 60 wt %.

In an embodiment of the disclosure, the bisphenol M-type cyanate ester resin includes:

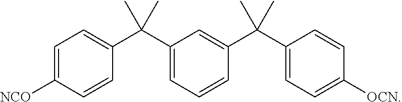

In an embodiment of the disclosure, the bismaleimide resin includes:

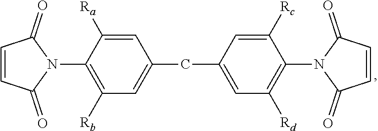

wherein Ra, Rb, Rc, and Rd are each independently an alkyl group having 1 to 5 carbon atoms.

In an embodiment of the disclosure, the resin further includes at least one of liquid rubber resin, polyphenylene ether resin, and crosslinking agent.

In an embodiment of the disclosure, the proportion of the liquid rubber resin in the resin is 0 wt % to 20 wt %, the proportion of the polyphenylene ether resin in the resin is between 10 wt % and 30 wt %, and the proportion of the crosslinking agent in the resin is between 0 wt % and 20 wt %.

In an embodiment of the disclosure, the amount of the flame retardants is between 5 parts by weight and 30 parts by weight based on 100 parts by weight of the resin in total.

In an embodiment of the disclosure, the amount of the inorganic fillers is between 80 parts by weight and 180 parts by weight based on 100 parts by weight of the resin in total.

In an embodiment of the disclosure, the amount of the accelerators is between 0.1 parts by weight and 2 parts by weight based on 100 parts by weight of the resin in total.

Based on the above, since bisphenol M-type cyanate ester resin has a longer chain (compared to bisphenol A-type cyanate ester), the resin composition of the disclosure may be adapted as a substrate material more suitable for 5G high frequency by selecting a resin including a bisphenol M-type cyanate ester resin and a bismaleimide resin, and it improves effectively the heat resistance and the electrical properties of the substrate made thereof.

The following embodiments are described in detail to make the features and advantage(s) of the disclosure more comprehensible.

### DESCRIPTION OF THE EMBODIMENTS

In this embodiment, the resin composition includes resin and other additives. The resins include bisphenol M-type cyanate ester resin and bismaleimide (BMI) resin, and the other additives are selected from at least one of flame retardants, inorganic fillers, and accelerators. Accordingly, since the bisphenol M-type cyanate ester resin has a longer chain and more benzene ring structures (compared to bisphenol A-type cyanate ester, that is,

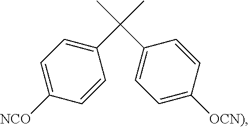

the electrical properties may be reduced. The resin composition of this embodiment is selected to include bisphenol M-type cyanate ester resin and bismaleimide resin. Therefore, when combined with bismaleimide resin, it may be adapted as a substrate material more suitable for 5G high-frequency, and it may improve effectively the heat resistance and the electrical properties of the substrate made thereof. Furthermore, with the above constitution, the resin composition of this embodiment has better heat resistance and maintains low coefficient of thermal expansion (CTE).

In one embodiment, the proportion of the bisphenol M-type cyanate ester resin in the resin is between 10 wt % and 30 wt % (for example, 10 wt %, 15 wt %, 20 wt %, 25 wt %, 30 wt %, or any value within the above range of 10% to 30%).

In one embodiment, the proportion of the bismaleimide resin in the resin is between 40 wt % and 60 wt % (for example, 40 wt %, 45 wt %, 50 wt %, 55 wt %, 60 wt %, or any value within the above range of 40 wt % to 60 wt %).

In one embodiment, the bisphenol M-type cyanate ester resin includes:

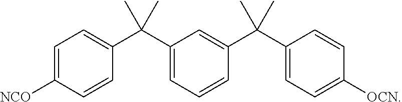

In one embodiment, the bismaleimide resin has bisphenol A as the main structure and is end-capped with maleimine, and an alkyl group with 1 to 5 carbon atoms is grafted on the main structure of bisphenol A. Specifically, the structure of the bismaleimide resin is shown in the following structural Formula:

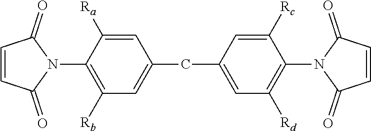

In this Formula, each of Ra, Rb, Rc, and Rd is independently an alkyl group having 1 to 5 carbon atoms. In one embodiment, Ra, Rb, Rc, and Rd are each independently an alkyl group having 1 to 3 carbon atoms. In one embodiment, Ra and Rc are methyl groups, and Rb and Rd are ethyl groups. However, the disclosure is not limited thereto.

In one embodiment, the resin may further include one or more of polyphenylene ether resin, crosslinking agent, and liquid rubber resin, where the proportion of polyphenylene ether resin in the resin is between 10 wt % and 30 wt % (for example, 10 wt %, 15 wt %, 20 wt %, 25 wt %, 30 wt %, or any value within the above range of 0 wt % to 30 wt %), the proportion of crosslinking agent in the resin is between 0 wt % and 20 wt % (for example, 0 wt %, 5 wt %, 10 wt %, 15 wt %, 20 wt %, or any value within the above range of 0 wt % to 20 wt %), and the proportion of liquid rubber resin in the resin is between 0 wt % and 20 wt % (for example, 0 wt %, 5 wt %, 10 wt %, 15 wt %, 20 wt %, or any value within the above range of 0 wt % to 20 wt %).

In an embodiment, the liquid rubber resin is polybutadiene and has the following structure:

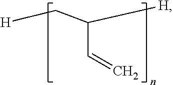

where n=15 to 25; for example, n=16 to 22.

In one embodiment, the liquid rubber resin may be polyolefin, and it includes but not limited to: styrene-butadiene-divinylbenzene terpolymer, styrene-butadiene-maleic anhydride terpolymer, vinyl-polybutadiene-urethane oligomer, styrene-butadiene copolymer, hydrogenated styrene-butadiene copolymer, styrene-isoprene copolymer, hydrogenated styrene-isoprene copolymer, hydrogenated styrene-butadiene-divinylbenzene copolymer, polybutadiene (homopolymer of butadiene), maleic anhydride-styrene-butadiene copolymer, methylstyrene copolymer, or a combination thereof.

In one embodiment, the liquid rubber resin has 1,2 vinyl with a molar ratio of 10% to 90% or styrene with a molar ratio of 0% to 50%. The molecular weight may be between 1000 and 5000 to crosslink with other resins effectively and improve compatibility, but the disclosure is not limited thereto.

In one embodiment, the polyphenylene ether resin is a thermosetting polyphenylene ether resin and is a composition having styrene-type polyphenylene ether and terminal acrylic polyphenylene ether in its terminal groups. For example, the structure of the styrene-based polyphenylene ether is shown in Formula (A):

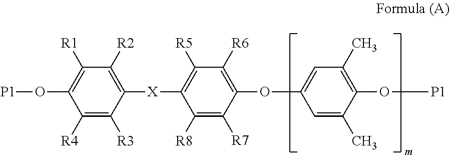

In Formula (A), R1 to R8 may be a hydrogen atom, an allyl group, a C1 to C6 alkyl group, or one or more selected from the above group, and two of R1 to R8 may be the same or different; x may be: a single bond, 0 (oxygen atom) or the following linking groups:

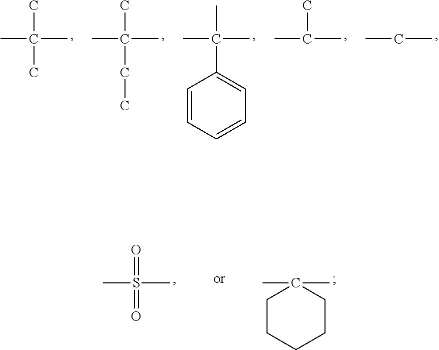

P1 may be styryl

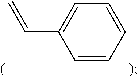

m may be an integer ranging from 1 to 99.

The structure of acrylic polyphenylene ether at the end is shown in Formula (B):

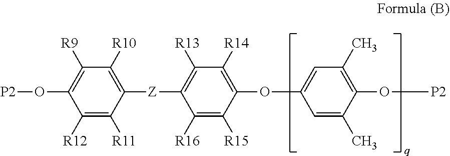

In Formula (B), R9 to R16 may be hydrogen atom, allyl group, C1 to C6 alkyl group, or one or more selected from the above groups, and two of R9 to R16 may be the same or different; z may be: a single bond, 0 (oxygen atom), or the following linking groups:

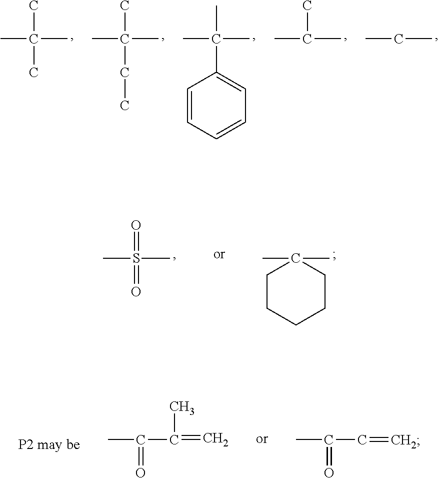

and q may be an integer ranging from 1 to 99.

Specific examples of polyphenylene ether resins include, but are not limited to: dihydroxy polyphenylene ether resin (for example: the resin purchased from Saudi Basic Industries Corporation (SABIC) under the product name SA-90), ethylene benzyl polyphenylene ether resin (for example: the resin purchased from Mitsubishi Gas Chemical Company, Inc. under the product name OPE-2st), methacrylate polyphenylene ether resin (for example: resin purchased from SABIC under the product name SA-9000), vinyl-benzyl modified bisphenol A polyphenylene ether resin or vinyl chain-extended saw phenylene ether resin. In one embodiment, the aforementioned polyphenylene ether is vinyl polyphenylene ether.

In one embodiment, the crosslinking agent is adapted to increase the crosslinking degree of the thermosetting resin, adjust the rigidity and toughness of the substrate, and adjust the processability. It may be a combination of one or more of 1,3,5-triallyl cyanurate (TAC), triallyl isocyanurate (TAIL), trimethallyl isocyanurate (TMAIC), diallyl phthalate, divinylbenzene, or 1,2,4-triallyltrimellitate.

In an embodiment, the resin composition further includes at least one of flame retardants, inorganic fillers, and accelerators. The amount of the flame retardants is between 5 parts by weight and 30 parts by weight based on 100 parts by weight of the resin in total (for example, 5 parts by weight, 10 parts by weight, 20 parts by weight, 30 parts by weight, or any value within the above range of 5 parts by weight to 30 parts by weight). The amount of the inorganic fillers is between 80 parts by weight and 180 parts by weight based on 100 parts by weight of the resin in total (for example, 80 parts by weight, 90 parts by weight, 100 parts by weight, 120 parts by weight, 140 parts by weight, 160 parts by weight, 180 parts by weight, or any value within the above range of 80 parts by weight to 180 parts by weight). And the amount of the accelerators is between 0.1 parts by weight and 2 parts by weight based on 100 parts by weight of the resin in total (for example, 0.1 parts by weight, 0.3 parts by weight, 0.5 parts by weight, 1 part by weight, 2 parts by weight, or any value within the above range of 0.1 parts by weight to 2 parts by weight). In one embodiment, the amount of the accelerators in an embodiment is 1 part by weight, but the disclosure is not limited thereto.

In an embodiment, the flame retardants may be a halogen-free flame retardant, and specific examples of the flame retardants include a phosphorus-based flame retardant, which may be selected from: phosphates, such as triphenyl phosphate (TPP), resorcinol bis(diphenylphosphate) (RDP), bisphenol A bis(diphenyl) phosphonates (BPAPP), bisphenol A bis(methyl) phosphonates (BBC), resorcinol diphosphate (CR-733S), resorcinol-bis(di-2,6-dimethylphenyl phosphate) (PX-200); phosphazenes, such as polybis(phenoxy)phosphazene (SPB-100); ammonium polyphosphates, melamine phosphate (MPP, namely melamine polyphosphate), melamine cyanurate; a combination of more than one of DOPO flame retardants, such as DOPO (for example, please refer to the Formula (C) below), DOPO-HQ (for example, please refer to the Formula (D) below), double DOPO derivative structure (for example, please refer to the Formula (E) below), etc.; aluminum-containing hypophosphorous acid lipids (for example, please refer to the Formula (F) below).

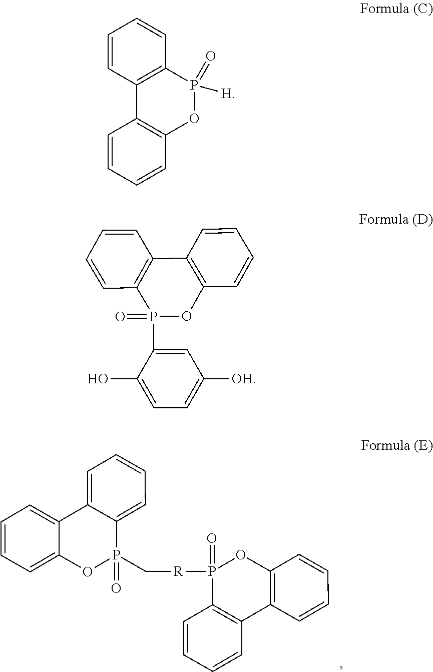

where R may be (CH₂)r,

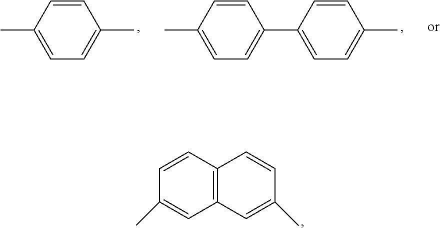

where r may be an integer ranging from 1 to 4.

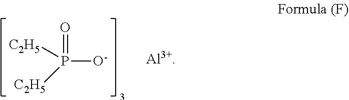

In one embodiment, the purpose of the inorganic fillers is to improve the mechanical strength and the dimensional stability of the resin composition after hardening. The composition of the inorganic filler is selected from one or more of spherical or irregular silicon dioxide (SiO₂), titanium dioxide (TiO₂), aluminum hydroxide (Al(OH)₃), aluminum oxide (Al₂O₃), magnesium hydroxide (Mg(OH)₂), oxide Magnesium (MgO), calcium carbonate (CaCO₃), boron oxide (B₂O₃), calcium oxide (CaO), strontium titanate (SrTiO₃), barium titanate (BaTiO₃), calcium titanate (CaTiO₃), magnesium titanate (2MgO.TiO₂), cerium oxide (CeO₂) or fume silica, boron nitride (BN), and aluminum nitride (AlN). In one embodiment, the average particle size of the inorganic fillers is 0.01 to 20 μm. The fume silica is a nano-sized porous silica particle with an addition proportion of 0.1 wt % to 10 wt % and an average particle size of 1 to 100 nm. In addition, silicon dioxide may be molten or crystalline. In view of the dielectric properties of the composition, it may be molten silicon dioxide, such as Pauline's 525ARI.

In one embodiment, the accelerator may include a catalyst and a peroxide to improve the reactivity of the system. Specifically, the catalyst includes 1-cyanoethyl-2-phenylimidazole (2PZCN; CAS: 23996-12-5), 1-benzyl-2-phenylimidazole (1B2PZ; CAS: 37734-89-7), thiabendazole (TBZ; CAS: 7724-48-3), or a combination thereof, whereas the imidazole compound that has the best improvement effect is, for example, 1-benzyl-2-phenylimidazole, but the disclosure is not limited thereto. The catalyst can select other suitable catalysts according to actual design requirements.

In one embodiment, the peroxide may be tert-butyl cumyl peroxide, dicumyl peroxide (DCP), benzoyl peroxide (BPO), 2,5-dimethyl-2,5-di(tert-butylperoxy)hexane, 2,5-dimethyl-2,5-di(tert-butylperoxy)hexyne, 1,1-di-(tert-butylperoxy)-3,3,5-trimethylcyclohexane, di(tert-butylperoxyisopropyl)benzene, and Luf, but the disclosure is not limited to these examples.

Note that the specific embodiments listed above are not limitations of the disclosure. As long as the resin of the resin composition includes bisphenol M-type cyanate ester resin and bismaleimide resin, it is within the protection scope of the disclosure.

The following examples and comparative examples are listed to illustrate the effects of the disclosure, but the protection scope of the disclosure is not limited to the scope of the examples.

The copper foil substrates in the respective examples and comparative examples were evaluated based on the following processes.

The glass transition temperature (° C.) was tested with a dynamic mechanical analyzer (DMA).

The 288° C. solder resistance and heat resistance (seconds): after the sample was heated in a pressure cooker of 120° C. and 2 atm for 120 minutes, it was immersed in a soldering furnace at 288° C., and the time required for the sample to explode and delaminate was recorded.

The dielectric constant (Dk): the dielectric constant (Dk) was measured at a frequency of 10 GHz by the Agilent E4991A dielectric analyzer.

The dielectric loss (DO: the dielectric loss (DO was measured at a frequency of 10 GHz by the Agilent E4991A dielectric analyzer.

Copper foil peel strength (lb/in): the peel strength between the copper foil and the circuit carrier was tested.

### Examples 1 to 2 and Comparative Example 1

The resin composition in Table 1 was mixed with toluene to form a varnish of a thermosetting resin composition, and the varnish was impregnated with NAN YA fiberglass cloth (NAN YA PLASTICS CORPORATION; cloth type: 2013) at room temperature, then dried at 130° C. (by an impregnation machine) for a few minutes to obtain a prepreg with a resin content of 60 wt %. Lastly, four pieces of prepregs are layered on top of each other between two copper foils with a 35 μm thickness, and kept at a constant temperature for 20 minutes at a pressure of 25 kg/cm² and a temperature of 85° C., and after heated to 185° C. at a heating rate of 3° C./min, it is kept at a constant temperature for another 120 minutes, and then slowly cooled to 130° C. to obtain a 0.5 mm thick copper foil substrate.

The physical properties of the copper foil substrate as prepared were tested, and the results are shown in Table 1 in detail. After comparing the results of Examples 1 to 2 and Comparative Example 1 in Table 1, the following conclusions may be drawn: compared with Comparative Example 1, Examples 1 to 2 may be adapted as a substrate material more suitable for 5G high frequency and may improve effectively the heat resistance and the electrical properties of the substrates made thereof.

TABLE 1

| | | Example | | | | Comparative Example | |
|---|---|---|---|---|---|---|---|
| Parts by weight | | 1 | | 2 | | 1 | |
| Resin | Cyanate esters | — | | — | | 20 | wt % |
| (total 100 | (BA230S of Lonza) | | | | | | |
| parts by | Cyanate esters (BPM | 20 | wt % | 20 | wt % | — | |
| weight) | sigma; CAS. 127667-44-1) | | | | | | |
| | Bismaleimide resin (KI-70) | 50 | wt % | — | | 50 | wt % |
| | Bismaleimide resin (X9470) | — | | 50 | wt % | — | |
| | Polyphenylene ether resin | 10 | wt % | 10 | wt % | 10 | wt % |
| | (SA9000) | | | | | | |
| | Crosslinking agent (TAIC) | 10 | wt % | 10 | wt % | 10 | wt % |
| | Liquid rubber resin | 10 | wt % | 10 | wt % | 10 | wt % |
| | (polybutadiene activ1000) | | | | | | |
| Other | Flame retardant | 17.5 | parts by mass | 17.5 | parts by mass | 8.6 | parts by mass |
| additives | (Examples: mosaflam 858 | | | | | | |
| (relative | of UFC CORPORATION; | | | | | | |
| to 100 | Comparative Example: | | | | | | |
| parts by | Exolit ® OP935) | | | | | | |
| weight of | Inorganic filler | 162.9 | parts by mass | 162.9 | parts by mass | 162.9 | parts by mass |
| resin | (silica adamatech Sc2500) | | | | | | |
| | Accelerator (1-benzyl-2- | 0.3 | parts by mass | 0.3 | parts by mass | 0.3 | parts by mass |
| | phenylimidazole) | | | | | | |
| | Accelerator (Luf) | 0.3 | parts by mass | 0.3 | parts by mass | 0.3 | parts by mass |

| Glass transition temperature (° C.) | 250 | 238 | 266.9 |
|---|---|---|---|
| Heat resistance | pass | pass | pass |
| Electrical properties (Dk/Df) | 3.3/0.0025 | 3.3/0.002 | 3.4/0.0035 |
| Peel strength (lb/in) | 3.4 | 3.35 | 3.44 |

In summary, since bisphenol M-type cyanate ester resin has a longer chain (compared to bisphenol A-type cyanate ester), the resin composition of the disclosure may be adapted as a substrate material more suitable for 5G high frequency by selecting a resin including a bisphenol M-type cyanate ester resin and a bismaleimide resin, and it improves effectively the heat resistance and the electrical properties of the substrate made thereof.

Although the disclosure has been disclosed in the above embodiments, it is not intended to limit the disclosure. Anyone with ordinary knowledge in the technical field can make changes and modifications without departing from the spirit and scope of the disclosure. The scope of protection of the disclosure shall be subject to those defined by the claims attached.

What is claimed is:

1. A resin composition, comprising:
resin, comprising bisphenol M-type cyanate ester resin and bismaleimide resin; and
other additives, selected from at least one of flame retardants, inorganic fillers, and accelerators.

2. The resin composition according to claim 1, wherein a proportion of the bisphenol M-type cyanate ester resin in the resin is 10 wt % to 30 wt %.

3. The resin composition according to claim 1, wherein a proportion of the bismaleimide resin in the resin is 40 wt % to 60 wt %.

4. The resin composition according to claim 1, wherein the bisphenol M-type cyanate ester resin comprises:

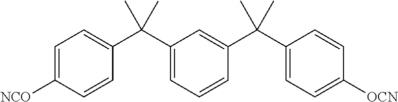

5. The resin composition according to claim 1, wherein the bismaleimide resin comprises: 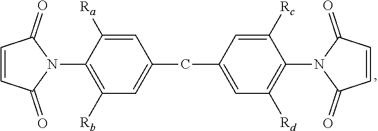
wherein Ra, Rb, Rc, and Rd are each independently an alkyl group having 1 to 5 carbon atoms.

6. The resin composition according to claim 1, wherein the resin further comprises at least one of liquid rubber resin, polyphenylene ether resin, and crosslinking agent.

7. The resin composition according to claim 6, wherein a proportion of the liquid rubber resin in the resin is 0 wt % to 20 wt %, a proportion of the polyphenylene ether resin in the resin is between 10 wt % and 30 wt %, and a proportion of the crosslinking agent in the resin is between 0 wt % and 20 wt %.

8. The resin composition according to claim 1, wherein an amount of the flame retardants is between 5 parts by weight and 30 parts by weight based on 100 parts by weight of the resin in total.

9. The resin composition according to claim 1, wherein an amount of the inorganic fillers is between 80 parts by weight and 180 parts by weight based on 100 parts by weight of the resin in total.

10. The resin composition according to claim 1, wherein an amount of the accelerators is between 0.1 parts by weight and 2 parts by weight based on 100 parts by weight of the resin in total.
